(19) United States
(12) Patent Application Publication
(10) Pub. No.: US 2026/0192515 A1
(43) Pub. Date: Jul. 9, 2026

(54) PRINTHEAD FOR A 3D PRINTER AND METHOD FOR OPERATING A PRINTHEAD FOR A 3D PRINTER

(71) Applicant: Robert Bosch GmbH, Stuttgart (DE)

(72) Inventor: Chris Nickels, Burgstetten-Erbstetten (DE)

(21) Appl. No.: 19/128,299

(22) PCT Filed: Nov. 22, 2023
(86) PCT No.: PCT/EP2023/082700

§ 371 Date: May 8, 2025

(30) Foreign Application Priority Data
Nov. 30, 2022 (DE) 10 2022 212 882.6

(51) Int. Cl. B29C 64/209; B29C 64/118; B29C 64/295; B33Y 30/00

(52) U.S. Cl. CPC B29C 64/209; B29C 64/118; B29C 64/295; B33Y 30/00

(57) ABSTRACT

The invention relates to a printhead (1) for a 3D printer comprising a nozzle head (2) having heating elements (3) for converting a material (4) from a solid phase to a liquid phase and a nozzle (5) for dispensing the liquid phase of the material (4) from the nozzle head (2).

The invention is characterized in that an adapter (10) is disposed in the area of the nozzle (5) of the nozzle head (2) and the adapter (10) comprises channels (11) for directing a temperature-controlled gas (15) towards the nozzle (5).

Further, the invention comprises a method for operating a printhead (1) according to the invention for a 3D printer.

### BACKGROUND

A 3D printer for a material that varies in viscosity receives a solid phase of said material as the starting material, generates a liquid phase therefrom, and selectively brings this liquid phase to the points associated with the object to be produced. Such a 3D printer comprises a printhead, in which the starting material is made ready for printing. Furthermore, means are provided for generating a relative movement between the printhead and the work surface on which the object is to be created. Either only the printhead, only the work surface or both the printhead and the work surface can be moved.

The printhead has a first operating state in which liquid material exits from it and a second operating state in which no liquid material exits from it. For example, the second operating state is assumed when another position on the work surface is approached and no material is to be discharged on the path. For example, it is possible to switch between the two operating states of the printhead, in that the forward drive of the solid starting material can be switched on or off.

The most common is fused deposition modeling (FDM), in which a filament is melted from the starting material in an electrically heated extruder nozzle and discharged layer by layer on a platform. In the form of such a filament, the starting material is very expensive.

DE 10 2017 212 305 discloses a 3D printer comprising a building chamber for receiving a substrate carrier on which a part can be built up in layers by a printhead, wherein means for local heating of the workpiece are disposed within the building chamber. These means may be heating elements for heating the substrate carrier or may be radiant heaters to heat the area directly surrounding the workpiece.

The disadvantage of these solutions is that not only the part to be printed, but also the entire workpiece and surrounding area are heated, which is not always useful for achieving the desired objective.

In DE 10 2021 202 628 A1, a printhead for a 3D printer with a nozzle head is disclosed, wherein a cooling ring for thermally shielding the surrounding environment from the printhead is disposed outside the nozzle head in the area of a nozzle.

DE 10 2017 211 279 A1 discloses an apparatus for producing three-dimensional objects comprising an extruder having an extruder nozzle for extruding a material, wherein the extruded material is cooled and thus solidified locally in the area around the extruder nozzle by a micro blower.

The disadvantage of the above-mentioned solution is that the cooling air acts on the removed material from one side, which may or may not be advantageous depending on the printing direction. Further, the required design space for the extruder expands, which can create collisions.

### SUMMARY

The invention is based on the task of providing a compact printhead for a 3D printer that allows for targeted thermal control with a highly dynamic printhead, and thereby a stable printing process.

The present invention relates to a printhead for a 3D printer and a method for operating a printhead for a 3D printer.

The printhead for a 3D printer comprises a nozzle head with heating elements for converting a material from a solid phase to a liquid phase and a nozzle for dispensing the liquid phase of the material from the nozzle head.

According to the invention, an adapter is disposed in the area of the nozzle of the nozzle head and the adapter comprises channels for guiding a temperature-controlled gas towards the nozzle. In a further development, the gas is a heated or a cooled gas, wherein the set temperature of the gas is adjusted or adjustable, respectively, according to the desired process result.

Because the adapter is arranged on the nozzle head and because the temperature-controlled gas is guided by channels in the adapter directly to the nozzle, it is advantageously achieved that the gas is guided locally to the location of the component to be printed, and is guided only on an as-needed basis. With heated gas, this measure prevents excessively rapid cooling of the component in production, which advantageously prevents deformations of the component or, for example, fractures in the material. The thermal influence at least achieves that, when printing the component, distortion is minimized and the entire component will have less distortion as a result.

This is achieved with heated gas, in particular by local heating, whereby better adhesion between the individual layers and better component quality are achieved. As a direct improvement, less distortion occurs, which proves advantageous in production in particular of large components. Local heating ensures better adhesion of the print layers, especially in the case of a re-attachment, for example after a so-called refill phase.

A further advantage is that a flexible use of gas or air to temper the component can be achieved by using the adapter, making it possible to switch the gas on or off dynamically.

When using cooled gas, targeted thermal influence makes it possible to dispense with or at least reduce support structures with when printing complex structures, thereby saving material in an advantageous manner. Also, printing cantilevered or overhanging structures or parts is possible.

It is further advantageous that a flatter design of the printhead or the extruder as well as, accordingly, a flatter design around the nozzle can be achieved by the inventive design of the printhead. Thus, collisions of attachments may be advantageously avoided, because said attachments are no longer present. In addition, the printing direction of the printhead no longer affects the thermal influence of the heated gas.

In one further development, the channels are arranged concentrically.

In one further development, the adapter comprises an inner ring and an outer ring, wherein in a preferred configuration, the inner ring and the outer ring form a gap for directing the gas.

In one further development, the inner ring is made of a thermally insulating material for thermally insulating the gas against the nozzle head. The inner ring, which can in particular be made from plastic, insulates the nozzle and thus the entire system of the nozzle head such that the gas temperature in the adapter has no effect on the temperature of the melt in the melt chamber.

In one further development, the inner ring comprises a contour that is suitable for influencing the direction of flow of the gas towards the nozzle opening.

The contour influences the direction of flow of the gas such that the gas is directed through the gap over the contour along the nozzle to the nozzle opening according to the Coandǎ effect. The Coandǎ effect describes a tendency of a gas jet or liquid current, wherein said jet or current flows along the curve of a curved surface due to the effect rather than becoming detached from it and continuing to move in the original direction of flow.

In one further development, the outer ring comprises an opening for introducing the gas into the adapter.

In one further development, the adapter is shaped like a cup. The cup-shaped configuration of the adapter encloses the nozzle head, which advantageously achieves a small design.

Further, the invention comprises a method for operating a printhead for a 3D printer, wherein temperature-controlled gas is directed to the nozzle of the nozzle head via the adapter.

Further measures for improving the invention are described in greater detail hereinafter, together with the description of the preferred exemplary embodiments of the invention, with reference to the figures.

### BRIEF DESCRIPTION OF THE DRAWINGS

Shown are:

FIG. 1 a cross-sectional drawing of a printhead 1 according to the invention, and

FIG. 2 an interior view of an outer ring 13 of an adapter 10.

### DETAILED DESCRIPTION

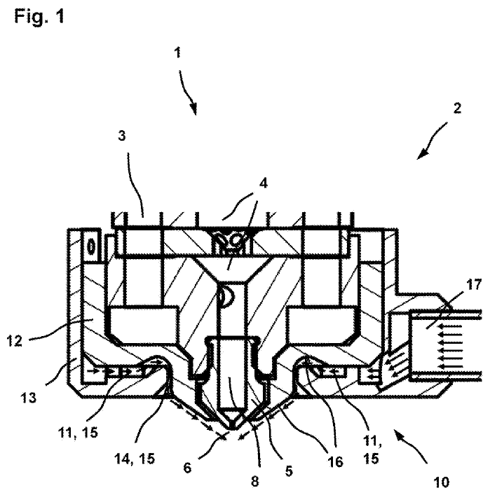

FIG. 1 shows a printhead 1 for a 3D printer comprising a nozzle head 2 with heating elements 3 for converting a material 4 from a solid phase to a liquid phase and a nozzle 5 for dispensing the liquid phase of the material 4 from the nozzle head 2. According to the invention, an adapter 10 is disposed in the area of the nozzle 5 of the nozzle head 2 and the adapter 10 comprises channels 11 for directing a temperature-controlled gas 15 towards the nozzle 5. The adapter 10 is shaped like a cup and encloses the nozzle head 2, wherein the adapter 10 is mounted on the lower part of the printhead 1 and/or the nozzle head 2.

The printable material 10 can in particular be material or starting material available as granulate.

The starting material 10 can in particular be a thermoplastic material.

A melt chamber 8 is disposed in the lower nozzle head 2, wherein this is configured to be funnel-shaped and tapered towards the nozzle 5.

The funnel-shaped or conical inlet of the melt chamber 8 allows an increase of the volume flow and prevents the material 10 from depositing on the inner wall of the nozzle head 2.

The adapter 10 comprises an inner ring 12 and an outer ring 13, wherein the inner ring 12 and the outer ring 13 form a gap 14 for directing the gas 15.

The inner ring 12 is made of a thermally insulating material for thermal insulation of the gas 15 against the nozzle head 2. The inner ring 12 and the outer ring 13 may also be manufactured in one piece, for example by 3D printing. The inner ring 12, which can preferably be made from an insulating material, in particular plastic, insulates the nozzle head 2 and thus the printhead 1, so that the temperature set in the printhead 1 in the melt chamber 8 is not influenced.

Further, the inner ring 12 has a contour 16, which is suitable for influencing the direction of flow of the gas 15 towards a nozzle opening 6 of the nozzle 5. The direction of flow of the gas 15 is shown by arrows starting from an opening 17 of the outer ring 13 via the channels 11 through the gap 14 to the nozzle opening 6. The contour 16 influences the direction of flow of the gas 15 such that the gas 15 is directed through the gap 14 over the contour 16 along the nozzle 5 to the nozzle opening 6 in accordance with the Coandǎ effect. The Coandǎ effect describes a tendency of a gas jet or liquid flow, wherein such jets or flows, rather than becoming detached and continuing in the original direction of flow, pass along the curve of a surface formed here by the contour 16.

The gas 15, which is directed into the adapter 10 via the opening 17, comes from a processing system which is not shown that provides heated and cooled gas 15 and directs it under pressure to the printhead 1 via the opening 17. The temperature of the gas 15 is based on the respective process requirements and can be adjusted in a flexible manner. For example, the gas 15 is pressurized, temperature-controlled air or temperature-controlled nitrogen. The gas 15 penetrates the outer ring 13 through the opening 17 and is subsequently directed through a plurality of apertures and channels 11 from all sides on the outer ring 13 to the center of the adapter 10. Through the gap 14 formed between the inner ring 12 and the outer ring 13, the pressurized gas 15 passes to the vicinity of the nozzle 6. As the gas 15 flows through the gap 14, it is not directed further directly in the axial direction of the adapter 10; instead, the flow follows the contour of the inner ring 12 as shown by the arrows.

The outer ring 13 comprises the opening 17 for introducing the gas 15 into the adapter 10.

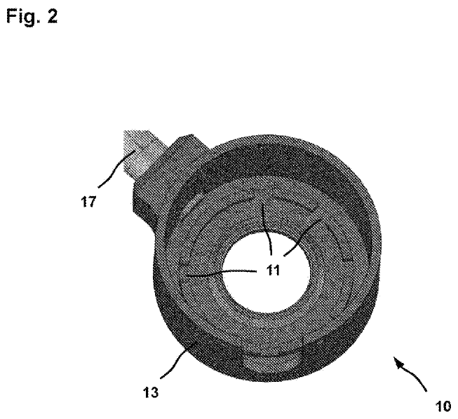

FIG. 2 shows an interior view of the outer ring 13 of the adapter 10.

The channels 11 and recesses are shown within the cup-shaped outer ring 13, and are in particular arranged concentrically. The opening 17 for introducing the gas 15 is arranged on the outer side of the outer ring 13.

1. A printhead (1) for a 3D printer, comprising:
a nozzle head (2) with heating elements (3) for converting a material (4) from a solid phase to a liquid phase and a nozzle (5) for dispensing the liquid phase of the material (4) from the nozzle head (2),
wherein
an adapter (10) is arranged in an area of the nozzle (5) of the nozzle head (2) and the adapter (10) comprises channels (11) for directing gas (15) towards the nozzle (5).

2. The printhead (1) according to claim 1,
wherein the gas (15) is a heated or a cooled gas (15).

3. The printhead (1) according to claim 1,
wherein the channels (11) are arranged concentrically.

4. The printhead (1) according to claim 1,
wherein the adapter (10) comprises an inner ring (12) and an outer ring (13).

5. The printhead (1) according to claim 4,
wherein the inner ring (12) and the outer ring (13) form a gap (14) for directing the gas (15).

6. The printhead (1) according to claim 4,
wherein the inner ring (12) is made of a thermally insulating material for thermal insulation of the gas (15) against the nozzle head (2).

7. The printhead (1) according to claim 4,
wherein the inner ring (12) has a contour (16) configured for influencing a direction of flow of the gas (15) towards a nozzle opening (6) of the nozzle (5).

8. The printhead (1) according to claim 4,
wherein the outer ring (13) comprises an opening (17) for introducing the gas (15) into the adapter (10).

9. The printhead (1) according to claim 1,
wherein the adapter (10) is cup-shaped.

10. A method for operating a printhead (1) for a 3D printer according to claim 1,
wherein
temperature-controlled gas (15) is directed to the nozzle (5) of the nozzle head (2) via the adapter (10).
